(19) United States
(12) Patent Application Publication
(10) Pub. No.: US 2018/0241617 A1
(43) Pub. Date: Aug. 23, 2018

(54) SYSTEM UPGRADE MANAGEMENT IN DISTRIBUTED COMPUTING SYSTEMS

(71) Applicant: Microsoft Technology Licensing, LLC, Redmond, WA (US)

(72) Inventors: Eric Radzikowski, Seattle, WA (US); Avnish Chhabra, Redmond, WA (US)

(21) Appl. No.: 15/450,788

(22) Filed: Mar. 6, 2017

Related U.S. Application Data
(60) Provisional application No. 62/462,163, filed on Feb. 22, 2017.

(51) Int. Cl. H04L 12/24; H04L 29/08

(52) U.S. Cl. CPC H04L 41/082; H04L 67/10

(57) ABSTRACT

Embodiments of system upgrade management in a cloud computing system are disclosed therein. In one embodiment, a computing device is configured to transmit, to a server in the cloud computing system, data representing an available upgrade applicable to a component of the server on which a virtual machine is executed to provide a corresponding cloud computing service to a tenant. The computing device is also configured to receive, from the server, a message containing a preferred time by the tenant to apply the available upgrade to the component of the server and in response to receiving the message, determine a time for applying the available upgrade to the component of the server in view of the preferred time by the tenant included in the received message and instruct the server to apply the upgrade to the component of the server according to the determined time.

### CROSS-REFERENCE TO RELATED APPLICATION(S)

This application is a non-provisional application of and claims priority to U.S. Provisional Application No. 62/462,163, filed on Feb. 22, 2017, the disclosure of which is incorporated herein in its entirety.

### BACKGROUND

Remote or “cloud” computing typically utilizes a collection of remote servers in datacenters to provide computing, data storage, electronic communications, or other cloud services. The remote servers can be interconnected by computer networks to form one or more computing clusters. During operation, multiple remote servers or computing clusters can cooperate to execute user applications in order to provide desired cloud services.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In cloud computing facilities, individual servers can provide computing services to multiple users or “tenants” by utilizing virtualization of processing, network, storage, or other suitable types of physical resources. For example, a server can execute suitable instructions on top of an operating system to provide a hypervisor for managing multiple virtual machines. Each virtual machine can serve the same or a distinct tenant to execute tenant software applications to provide desired computing services. As such, multiple tenants can share physical resources at the individual servers in cloud computing facilities. On the other hand, a single tenant can also consume resources from multiple servers, storage devices, or other suitable components of a cloud computing facility.

Resources in cloud computing facilities can involve one-time, periodic, or occasional upgrades in software, firmware, device drivers, etc. For example, software upgrades for operating systems, hypervisors, or device drivers may be desired when new versions are released. In another example, firmware on network routers, switches, firewalls, power distribution units, or other components may be upgraded to correct software bugs, improve device performance, or introduce new functionalities.

One challenge in maintaining proper operations in cloud computing facilities is manage workflows (e.g., timing and sequence) of upgrading resources in the cloud computing facilities. For example, when a new version of a hypervisor is released, a server having an old version may be supporting virtual machines currently executing tenant software applications. As such, immediately upgrading the hypervisor on the server can cause interruption to the provided cloud services, and thus negatively impact user experience. In another example, servers that may be upgraded immediately may need to wait until an assigned time to receive the upgrades, at which time the servers may be actively executing tenant software applications again.

One technique to managing upgrade workflows in cloud computing facilities involves a platform controller designating upgrade periods and components throughout a cloud computing facility. Before a server is upgraded, the upgrade controller can cause virtual machines to be migrated from the server to a backup server before the server is upgraded. After the server is upgraded, the upgrade controller can cause the virtual machines be migrated back from the backup server. Drawbacks of this technique include additional costs in providing the backup servers, interruption to cloud services during migration of virtual machines, and complexity in managing associated operations.

Several embodiments of the disclosed technology can address at least some aspects of the foregoing challenge by providing an upgrade service configurable by a tenant to provide input on up-coming upgrade workflows. In certain embodiments, an upgrade controller can publish a list of available upgrades to an upgrade service associated with a tenant. The list of upgrades can include software or firmware upgrades to various servers or other resources supporting cloud services provided to the tenant. The upgrade service can be configured to maintain and monitor the cloud services (e.g., virtual machines) currently executing on the various servers and other components of a cloud computing facility by utilizing reporting agents, query agents, or by applying other suitable techniques.

Upon receiving the list of upgrades, the upgrade service can be configured to provide the upgrade controller a set of times and/or sequences according to which components hosting the various cloud services of the tenant may be upgraded. For example, the upgrade service can determine that a server hosting a virtual machine providing a storage service can be immediately upgraded because sufficient number of copies of tenant data have been replicated in the cloud computing facility. In another example, the upgrade service can determine that the server hosting the virtual machine providing the storage service can be upgraded only after another copy has been replicated. In a further example, the upgrade service can determine that a session service (e.g., video games, VoIP calls, online meetings, etc.) is scheduled or expected to be completed at a certain later time. As such, the upgrade service can inform the upgrade controller that components hosting a virtual machine providing the session service cannot be upgraded immediately, but instead can be upgraded at that later time.

Upon receiving the set of times and/or sequences provided by the upgrade service of the tenant, the upgrade controller can be configured to generate, modify, or otherwise establish an upgrade workflow for applying the list of upgrades to the servers or other resources supporting the cloud services of the tenant. For example, in response to receiving an indication that the virtual machine supporting the storage service can be immediately upgraded, the upgrade controller can initiate an upgrade process on the server supporting the virtual machine immediately if the server is not also supporting other tenants. During the upgrade process, the server may be rebooted one or more times or otherwise being unavailable for executing the storage service in the virtual machine. In another example, the upgrade controller can arrange application of upgrades based on the received sequences from the upgrade service. In further examples, the upgrade controller can delay upgrading certain servers or other resources based on the set of times and/or sequences provided by the upgrade service of the tenant.

When a server or other components support multiple tenants, the upgrade controller can be configured to generate, modify, or otherwise establish the upgrade workflow based on inputs from multiple tenants. In one example, the upgrade controller can decide to upgrade a server immediately when a majority of tenants prefer to upgrade the server immediately. In another example, the upgrade controller can decide to upgrade the server when all tenants prefer to upgrade the server immediately. In further examples, preferences from different tenants may carry different weights. In yet further examples, other suitable decision making techniques may also be applied to derive the upgrade workflow.

In certain embodiments, the upgrade controller can also be configured to enforce upgrade rules (e.g., progress rules, deadline rules, etc.) for applying the list of upgrades. If a tenant violates one or more of the upgrade rules, the tenant's privilege on providing input to the upgrade workflows can be temporarily or permanently revoked. For example, the upgrade controller can determine if a tenant has provided preferences to initiate at least one upgrade within 30 minutes (or other suitable thresholds) after receiving the list of upgrades. In another example, the upgrade controller can determine the list of upgrades have been all applied to components supporting the cloud services of the tenant within 40 hours (or other suitable thresholds). If the tenant violates such rules, the upgrade controller can initiate upgrade workflows according to certain system policies, such as upgrading rack-by-rack, by pre-defined sets, etc.

Several embodiments of the disclosed technology can improve speed and safety of applying upgrades in a distributed computing environment. Unlike in conventional techniques, upgrade timing and/or sequence can be determined based on preferences from the tenants, not predefined system policies. As such, servers or other resources that are indicated to be immediately upgradable can be upgraded without any delay caused by the predefined system policies. Also, upgrades on servers or other resources supporting on-going cloud services to tenants can be delayed such that interruption to providing the cloud services can be at least reduced.

### BRIEF DESCRIPTION OF THE DRAWINGS

FIG. 1 is a schematic diagram illustrating a cloud computing system suitable for implementing system upgrade management techniques in accordance with embodiments of the disclosed technology.

FIGS. 2A-2C are schematic block diagrams showing hardware/software modules of certain components of the cloud computing environment in FIG. 1 during upgrade operations when the hosts serve a single tenant in accordance with embodiments of the present technology.

FIGS. 3A-3C are schematic block diagrams showing hardware/software modules of certain components of the cloud computing environment in FIG. 1 during upgrade operations when the hosts serve multiple tenants in accordance with embodiments of the present technology.

FIG. 4 is a block diagram showing software components suitable for the upgrade controller of FIGS. 2A-3C in accordance with embodiments of the present technology.

FIG. 5 is a block diagram showing software components suitable for the upgrade service of FIGS. 2A-3C in accordance with embodiments of the present technology.

FIGS. 6A and 6B are flow diagrams illustrating aspects of a process for system upgrade management in accordance with embodiments of the present technology.

FIG. 7 is a flow diagram illustrating aspects of another process for system upgrade management in accordance with embodiments of the present technology.

FIG. 8 is a computing device suitable for certain components of the cloud computing system in FIG. 1.

### DETAILED DESCRIPTION

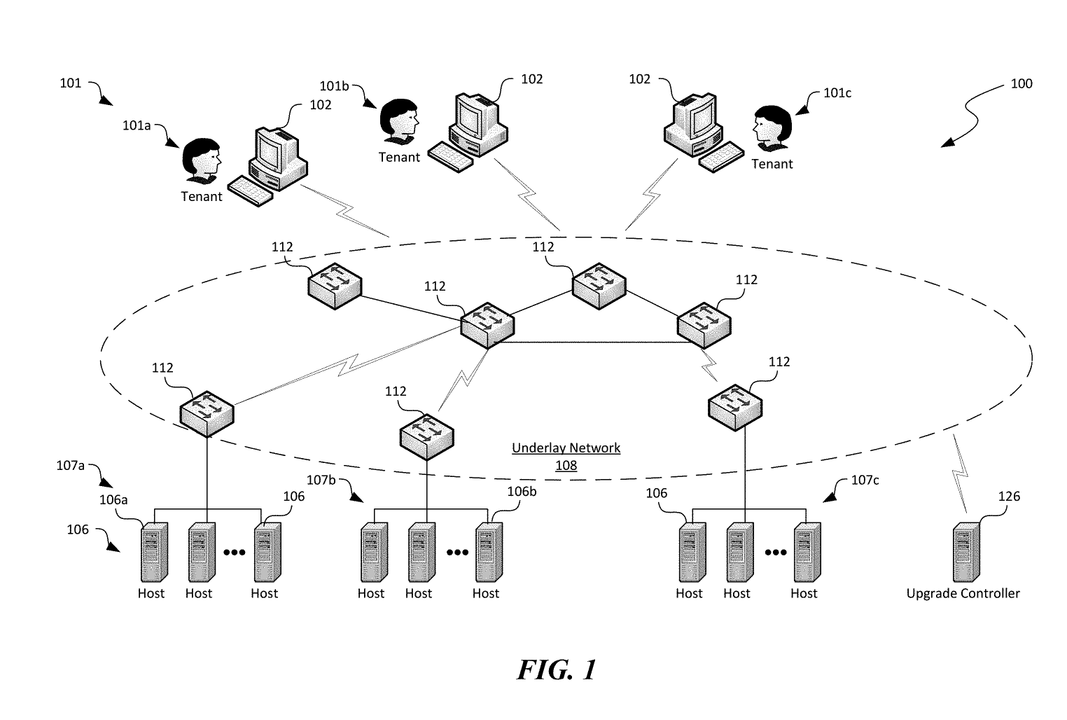

Various embodiments of computing systems, devices, components, modules, routines, and processes related to network traffic management in computing devices and systems are described below. In the following description, example software codes, values, and other specific details are included to provide a thorough understanding of various embodiments of the present technology. A person skilled in the relevant art will also understand that the technology may have additional embodiments. The technology may also be practiced without several of the details of the embodiments described below with reference to FIGS. 1-8.

As used herein, the term a “cloud computing system” generally refers to an interconnected computer network having a plurality of network devices that interconnect a plurality of servers or hosts to one another or to external networks (e.g., the Internet). The term “network device” generally refers to a physical network device, examples of which include routers, switches, hubs, bridges, load balancers, security gateways, or firewalls. A “host” generally refers to a computing device configured to implement, for instance, one or more virtual machines or other suitable virtualized components. For example, a host can include a server having a hypervisor configured to support one or more virtual machines or other suitable types of virtual components.

A computer network can be conceptually divided into an overlay network implemented over an underlay network. An “overlay network” generally refers to an abstracted network implemented over and operating on top of an underlay network. The underlay network can include multiple physical network devices interconnected with one another. An overlay network can include one or more virtual networks. A “virtual network” generally refers to an abstraction of a portion of the underlay network in the overlay network. A virtual network can include one or more virtual end points referred to as “tenant sites” individually used by a user or “tenant” to access the virtual network and associated computing, storage, or other suitable resources. A tenant site can have one or more tenant end points (“TEPs”), for example, virtual machines. The virtual networks can interconnect multiple TEPs on different hosts. Virtual network devices in the overlay network can be connected to one another by virtual links individually corresponding to one or more network routes along one or more physical network devices in the underlay network.

Also used herein, a “upgrade” generally refers to a process of replacing a software or firmware product (or a component thereof) with a newer version of the same product in order to correct software bugs, improve device performance, introduce new functionalities, or otherwise improve characteristics of the software product. In one example, an upgrade can include a software patch to an operating system or a new version of the operating system. In another example, an upgrade can include a new version of a hypervisor, firmware of a network device, device drivers, or other suitable software components. Available upgrades to a server or a network device can be obtained via automatic notifications from device manufactures, querying software depositories, input from system administrators, or via other suitable sources.

In addition, as used herein, the term “cloud computing service” or “cloud service” generally refers to one or more computing resources provided over a computer network such as the Internet by a remote computing facility. Example cloud services include software as a service (“SaaS”), platform as a service (“PaaS”), and infrastructure as a service (“IaaS”). SaaS is a software distribution technique in which software applications are hosted by a cloud service provider in, for instance, datacenters, and accessed by users over a computer network. PaaS generally refers to delivery of operating systems and associated services over the computer network without requiring downloads or installation. IaaS generally refers to outsourcing equipment used to support storage, hardware, servers, network devices, or other components, all of which are made accessible over a computer network.

Also used herein, the term “platform controller” generally refers to a cloud controller configured to facilitate allocation, instantiation, migration, monitoring, applying upgrades, or otherwise manage operations related to components of a cloud computing system in providing cloud services. Example platform controllers can include a fabric controller such as Microsoft Azure® controller, Amazon Web Service (AWS) controller, Google Cloud Upgrade controller, or a portion thereof. In certain embodiments, a platform controller can be configured to offer representational state transfer (“REST”) Application Programming Interfaces (“APIs”) for working with associated cloud facilities such as hosts or network devices. In other embodiments, a platform controller can also be configured to offer a web service or other suitable types of interface for working with associated cloud facilities.

In cloud computing facilities, a challenge in maintaining proper operations is proper management of upgrade workflow of resources in the cloud computing facilities. Currently, an upgrade controller (e.g., Microsoft Azure® controller) can select timing and sequence of applying various updates to resources based on tenant agreements, prior agreements, or other system policies. Such application of upgrades can be inefficient and can result in interruptions to cloud services provided to tenants. For example, when a new version of an operating system is released, a server having an old version of the operating system may be actively supporting virtual machines executing software applications to provide suitable cloud services. As such, applying the new version of the operating system would likely cause interruption to the provided cloud services.

Several embodiments of the disclosed technology can address at least some of the foregoing challenge by allowing tenants to influence an upgrade workflow within certain boundaries. In certain implementations, an upgrade controller can collect and publish a list of upgrades to a tenant service (referred to as the “upgrade service herein”) associated with a tenant. The list of upgrades can include software or firmware upgrades to various servers or other resources supporting cloud services provided to the tenant. The upgrade service can be configured to monitor cloud services (e.g., virtual machines) of the tenant currently executing on the various hosts and other components of a cloud computing facility by utilizing reporting agents at the servers or other suitable techniques. The upgrade service can be configured to provide the upgrade controller a set of times and/or sequences according to which components hosting the various services of the tenant may be upgraded. The upgrade service can determine the set of times and/or sequences by, for example, comparing the current status of the monitored cloud services with a set of rules configurable by the tenant. The upgrade controller can then develop an upgrade workflow in view of the received set of times and/or sequences from the upgrade service. As such, interruptions to the cloud services provided to the tenant can be at least reduced if not eliminated, as described in more detail below with reference to FIGS. 1-8.

FIG. 1 is a schematic diagram illustrating a distributed computing environment 100 suitable for implementing system upgrade management techniques in accordance with embodiments of the disclosed technology. As shown in FIG. 1, the distributed computing environment 100 can include an underlay network 108 interconnecting a plurality of hosts 106, a plurality of client devices 102, and an upgrade controller 126 to one another. The individual client devices 102 are associated with corresponding tenants 101a-101c. Even though particular components of the distributed computing environment 100 are shown in FIG. 1, in other embodiments, the distributed computing environment 100 can also include network storage devices, maintenance managers, and/or other suitable components (not shown) in addition to or in lieu of the components shown in FIG. 1.

The client devices 102 can each include a computing device that facilitates corresponding tenants 101 to access cloud services provided by the hosts 106 via the underlay network 108. For example, in the illustrated embodiment, the client devices 102 individually include a desktop computer. In other embodiments, the client devices 102 can also include laptop computers, tablet computers, smartphones, or other suitable computing devices. Even though three tenants 101 are shown in FIG. 1 for illustration purposes, in other embodiments, the distributed computing environment 100 can facilitate any suitable number of tenants 101 to access cloud services provided by the hosts 106.

As shown in FIG. 1, the underlay network 108 can include multiple network devices 112 that interconnect the multiple hosts 106, the tenants 101, and the upgrade controller 126. In certain embodiments, the hosts 106 can be organized into racks, action zones, groups, sets, or other suitable divisions. For example, in the illustrated embodiment, the hosts 106 are grouped into three host sets identified individually as first, second, and third host sets 107a-107c. In the illustrated embodiment, each of the host sets 107a-107c is coupled to corresponding network devices 112a-112c, respectively, which are commonly referred to as “top-of-rack” or “TOR” network devices. The TOR network devices 112a-112c can then be coupled to additional network devices 112 to form a computer network in a hierarchical, flat, mesh, or other suitable types of topology. The underlay network 108 can allow communications among the hosts 106, the upgrade controller 126, and the tenants 101. In other embodiments, the multiple host sets 107a-107c can share a single network device 112 or can have other suitable arrangements.

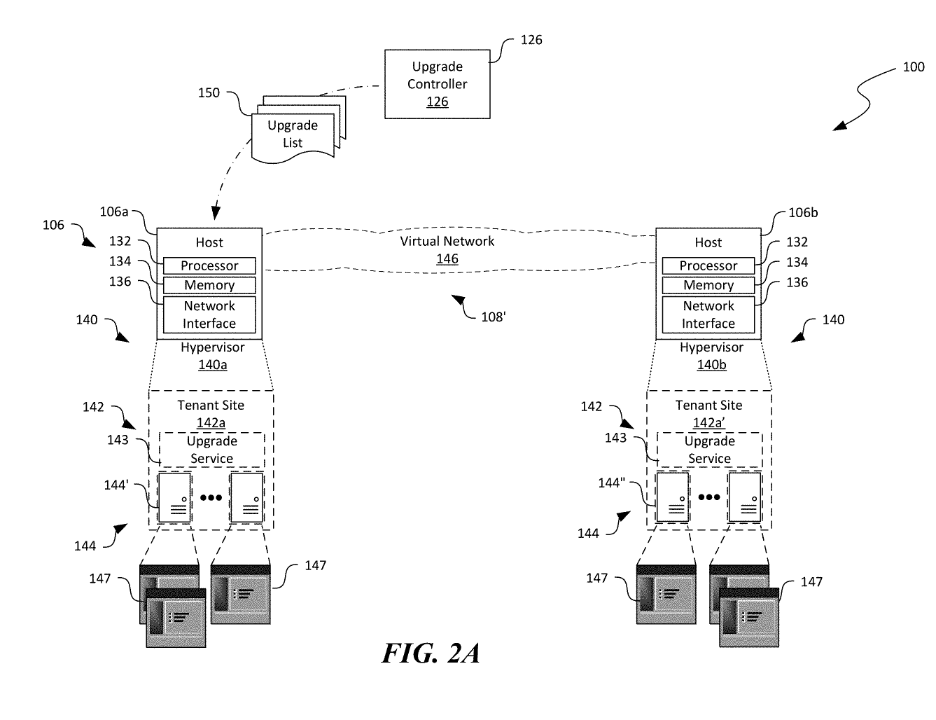

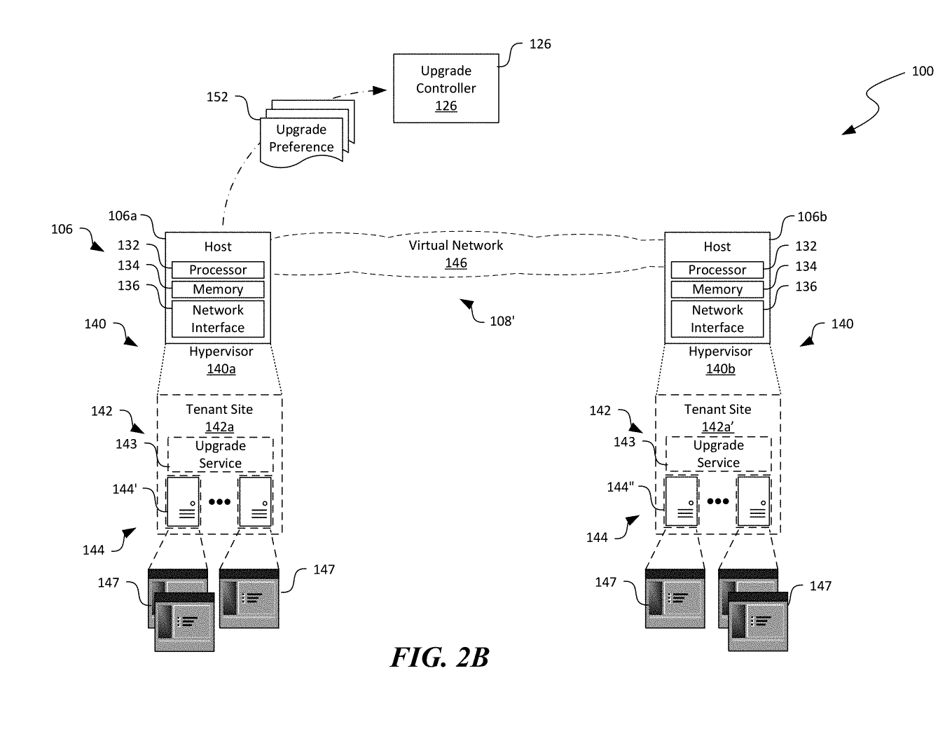

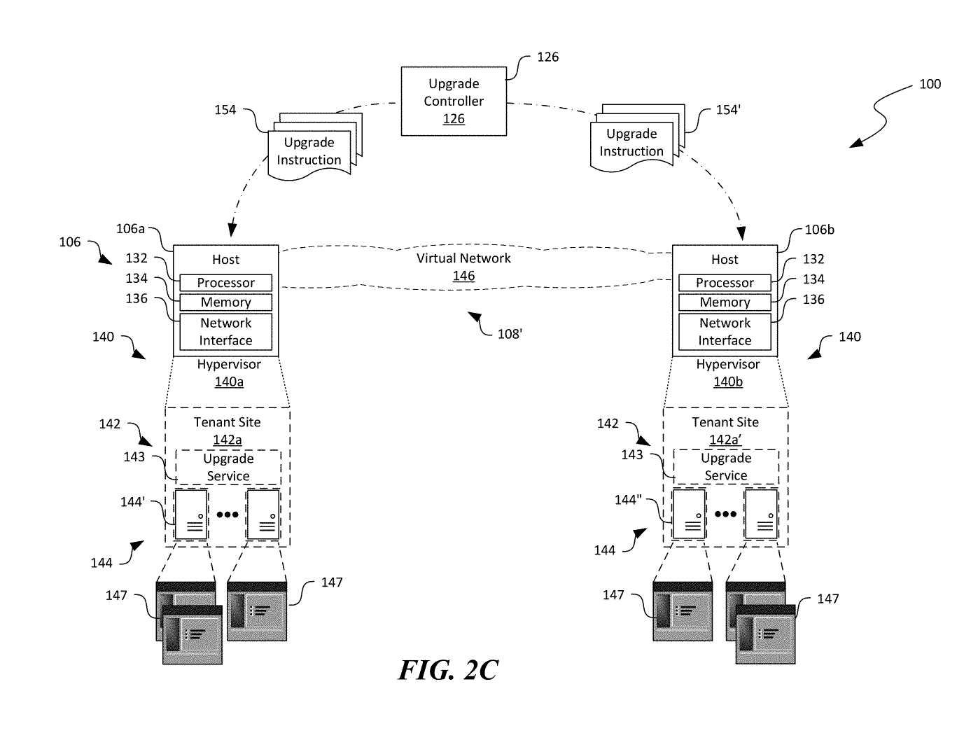

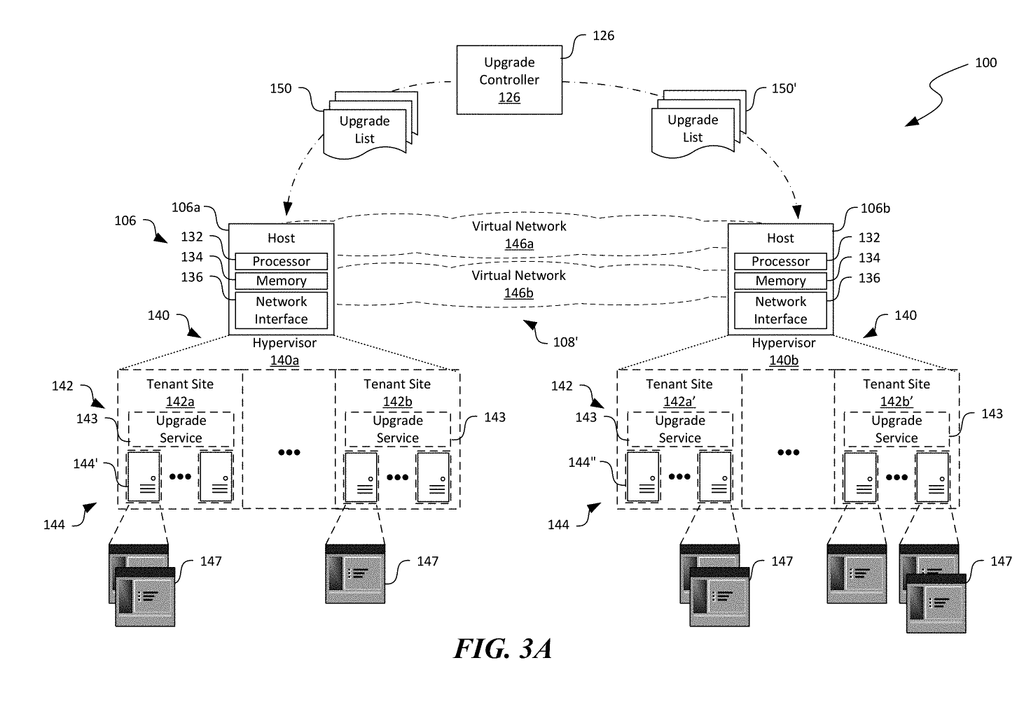

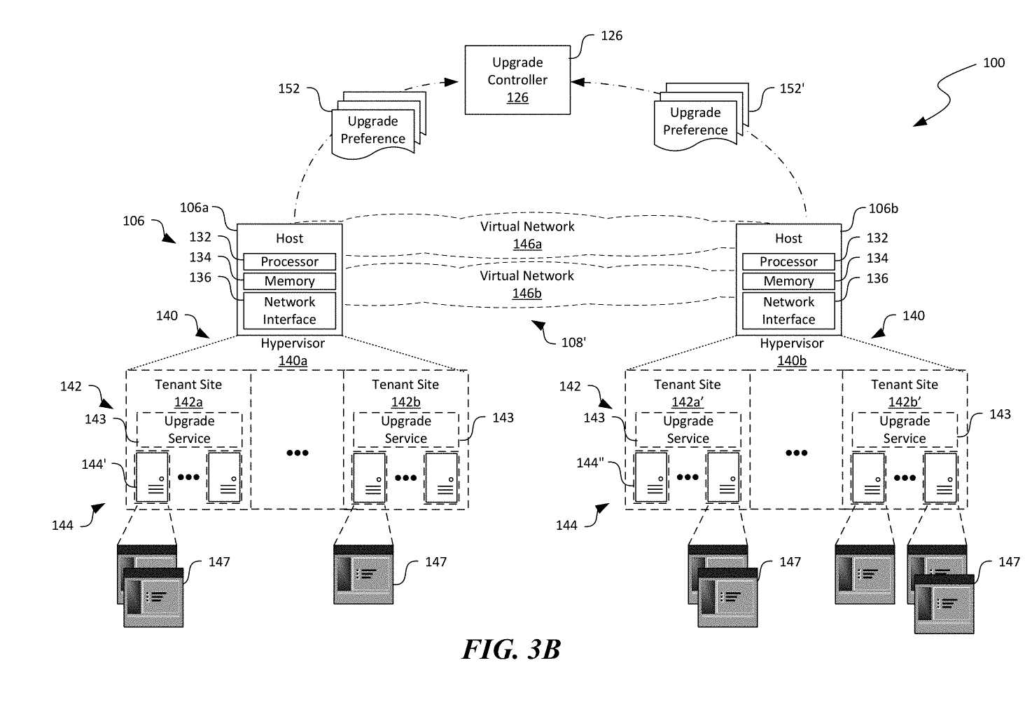

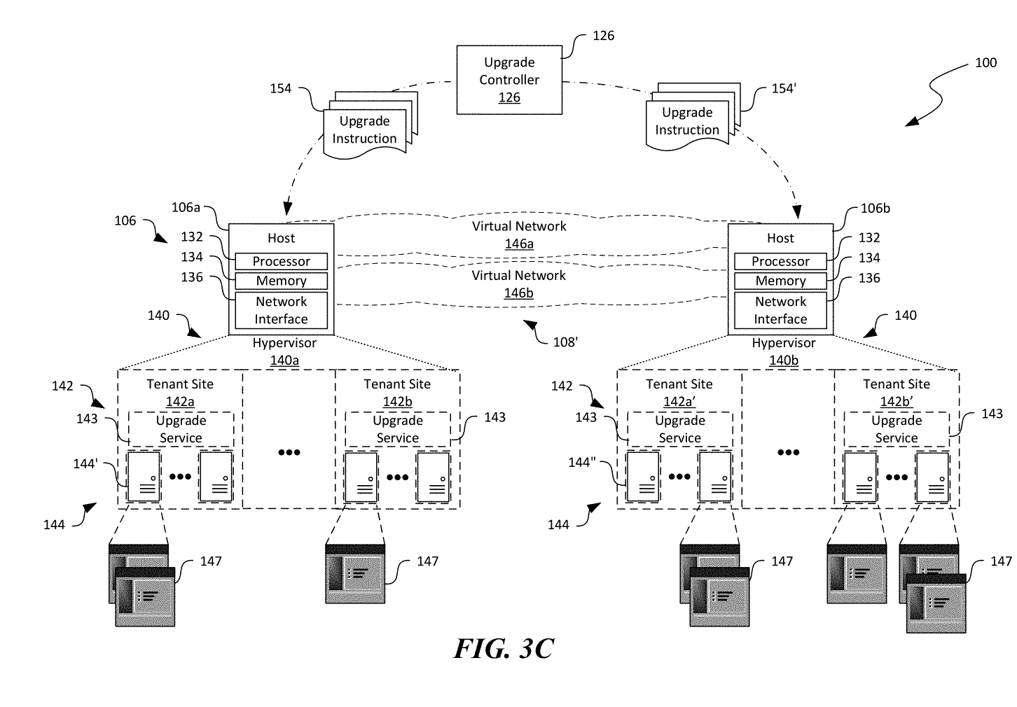

The hosts 106 can individually be configured to provide computing, storage, and/or other suitable cloud services to the individual tenants 101. For example, as described in more detail below with reference to FIGS. 2A-3C, each of the hosts 106 can initiate and maintain one or more virtual machines 144 (shown in FIG. 2) upon requests from the tenants 101. The tenants 101 can then utilize the instantiated virtual machines 144 to perform computation, communication, data storage, and/or other suitable tasks. In certain embodiments, one of the hosts 106 can provide virtual machines 144 for multiple tenants 101. For example, the host 106a can host three virtual machines 144 individually corresponding to each of the tenants 101a-101c. In other embodiments, multiple hosts 106 can host virtual machines 144 for the individual tenants 101a-101c.

The upgrade controller 126 can be configured to facilitate applying upgrades to the hosts 106, the network devices 112, or other suitable components in the distributed computing environment 100. In one aspect, the upgrade controller 126 can be configured to allow the individual tenants 101 to influence an upgrade workflow to the hosts 106. For example, the upgrade controller 126 can publish available upgrades to the hosts 106 and develop upgrade workflows based on responses received from the hosts 106. In another aspect, the upgrade controller 126 can also be configured to enforce certain rules regarding progress or completion of applying the available upgrades. Example implementations of the foregoing technique is described in more detail below with reference to FIGS. 2A-4. In the illustrated embodiment, the upgrade controller 126 is shown as a stand-alone server for illustration purposes. In other embodiments, the upgrade controller 126 can also be one of the hosts 106, a computing service provided by one or more of the hosts 106, or a part of a platform controller (not shown) of the distributed computing environment 100.

FIGS. 2A-2C are schematic block diagrams showing hardware/software modules of certain components of the cloud computing environment of FIG. 1 during upgrade operations when the hosts serve a single tenant in accordance with embodiments of the present technology. In FIGS. 2A-2C, only certain components of the underlay network 108 of FIG. 1 are shown for clarity. Also, in FIGS. 2A-2C and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may also include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component, and a third component. The foregoing components can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a tablet computer, a network server, a laptop computer, a smartphone, and/or other suitable computing devices.

Equally, components may include hardware circuitry. In certain examples, hardware may be considered fossilized software, and software may be considered liquefied hardware. As just one example, software instructions in a component may be burned to a Programmable Logic Array circuit, or may be designed as a hardware component with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media. As used herein, the term “computer readable storage media” excludes propagated signals.

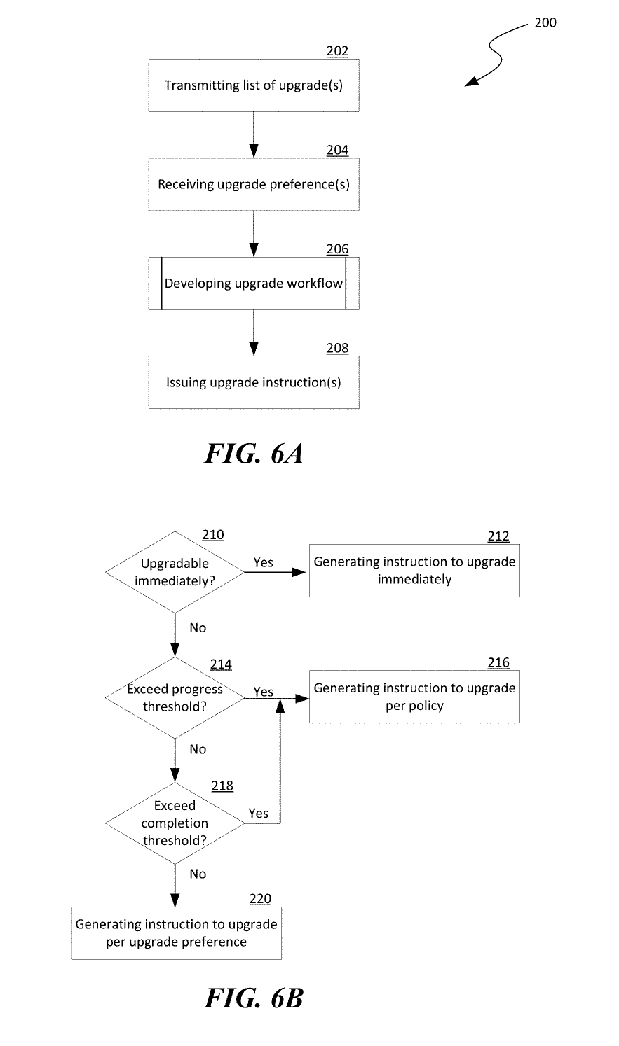

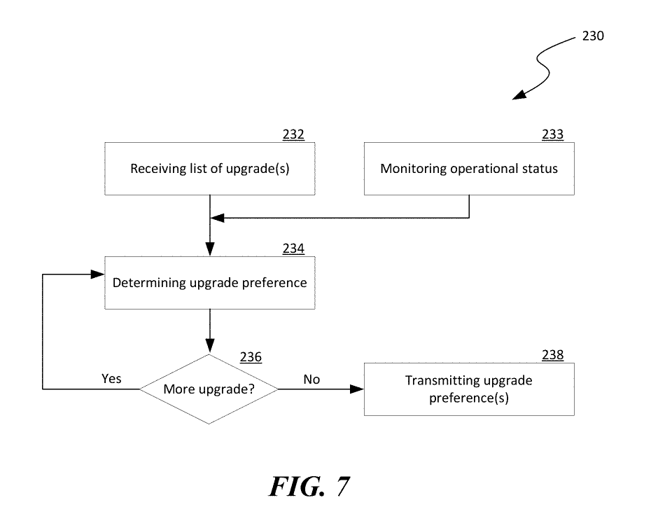

As shown in FIG. 2A, the first host 106a and the second host 106b can each include a processor 132, a memory 134, and a network interface 136 operatively coupled to one another. The processor 132 can include one or more microprocessors, field-programmable gate arrays, and/or other suitable logic devices. The memory 134 can include volatile and/or nonvolatile media (e.g., ROM; RAM, magnetic disk storage media; optical storage media; flash memory devices, and/or other suitable storage media) and/or other types of computer-readable storage media configured to store data received from, as well as instructions for, the processor 132 (e.g., instructions for performing the methods discussed below with reference to FIGS. 6A-7). The network interface 136 can include a NIC, a connection converter, and/or other suitable types of input/output devices configured to accept input from and provide output to other components on the virtual networks 146.

The first host 106a and the second host 106b can individually contain instructions in the memory 134 executable by the processors 132 to cause the individual processors 132 to provide a hypervisor 140 (identified individually as first and second hypervisors 140a and 140b). The hypervisors 140 can be individually configured to generate, monitor, migrate, terminate, and/or otherwise manage one or more virtual machines 144 organized into tenant sites 142. For example, as shown in FIG. 2A, the first host 106a can provide a first hypervisor 140a that manages a first tenant site 142a. The second host 106b can provide a second hypervisor 140b that manages a second tenant site 142a′.

The hypervisors 140 are individually shown in FIG. 2A as a software component. However, in other embodiments, the hypervisors 140 can also include firmware and/or hardware components. The tenant sites 142 can each include multiple virtual machines 144 for a particular tenant 101 (FIG. 1). For example, in the illustrated embodiment, the first host 106a and the second host 106b can host the first and second tenant sites 142a and 142a′ for a first tenant 101a (FIG. 1). In other embodiments, the first host 106a and the second host 106b can both host tenant site 142b and 142b′ for other tenants 101 (e.g., the second tenant 101b in FIG. 1), as described in more detail below with reference to FIGS. 3A-3C.

As shown in FIG. 2A, each virtual machine 144 can be executing a corresponding operating system, middleware, and one or more tenant software applications 147. The executed tenant software applications 147 can each correspond to one or more cloud services or other suitable types of computing services. For example, execution of the tenant software applications 147 can provide a data storage service that automatically replicates uploaded tenant data to additional hosts 106 in the distributed computing environment 101. In other examples, execution of the tenant software applications 147 can provide voice-over-IP conference calls, online gaming services, file management services, computational services, or other suitable types of cloud services. In certain embodiments, the tenant software applications 147 can be “trusted,” for example, when the tenant software applications 147 are released or verified by operators of the distributed computing environment 100. In other embodiments, the tenant software applications 147 can be “untrusted” when the tenant software applications 147 are third party applications or otherwise unverified by the operators of the distributed computing environment 100.

In certain implementations, the first and second hosts 106a and 106b can each host virtual machines 144 that execute different tenant software applications 147. In other implementations, the first and second hosts 106a and 106b can each host virtual machines 144 that execute a copy of the same tenant software application 147. For example, as shown in FIG. 2A, the first virtual machine 144′ hosted on the first host 106a and the second virtual machine 144″ hosted on the second host 106b can each be configured to execute a copy of the tenant software application 147. As described in more detail below, in any of the foregoing implementations, the tenant 101 having control of the first and second virtual machines 144′ and 144″ can utilize an upgrade service 143 to influence a timing and/or sequence of performing system upgrades on the first and second hosts 106a and 106b.

Also shown in FIG. 2A, the distributed computing environment 100 can include an overlay network 108′ implemented on the underlay network 108 in FIG. 1. The overlay network 108′ can include one or more virtual networks 146 that interconnect the first and second tenant sites 142a and 142a′ across the first and second hosts 106a and 106b. For example, in the illustrated embodiment, a first virtual network 142a interconnects the first tenant site 142a and the second tenant site 142a′ at the first host 106a and the second host 106b. In other embodiments as shown in FIGS. 3A-3C, a second virtual network 146b interconnects second tenant sites 142b and 142b′ at the first host 106a and the second host 106b. Even though a single virtual network 146 is shown as corresponding to one tenant site 142, in other embodiments, multiple virtual networks (not shown) may be configured to correspond to a single tenant site 146.

The overlay network 108′ can facilitate communications of the virtual machines 144 with one another via the underlay network 108 even though the virtual machines 144 are located or hosted on different hosts 106. Communications of each of the virtual networks 146 can be isolated from other virtual networks 146. In certain embodiments, communications can be allowed to cross from one virtual network 146 to another through a security gateway or otherwise in a controlled fashion. A virtual network address can correspond to one of the virtual machine 144 in a particular virtual network 146. Thus, different virtual networks 146 can use one or more virtual network addresses that are the same. Example virtual network addresses can include IP addresses, MAC addresses, and/or other suitable addresses. In operation, the hosts 106 can facilitate communications among the virtual machines 144 and/or tenant software applications 147 executing in the virtual machines 144. For example, the processor 132 can execute suitable network communication operations to facilitate the first virtual machine 144′ to transmit packets to the second virtual machine 144″ via the virtual network 146 by traversing the network interface 136 on the first host 106a, the underlay network 108, and the network interface 136 on the second host 106b.

As shown in FIG. 2A, the first and second hosts 106a and 106b can also execute suitable instructions to provide an upgrade service 143 to the tenant 101. In the illustrated embodiment, the upgrade service 143 is only shown as being hosted on the first host 106a. In other embodiments, the second host 106b can also host another upgrade service (not shown) operating as a backup, a peer, or in other suitable fashions with the upgrade service 143 in the first host 106a. In certain embodiments, the upgrade service 143 can include a software application executing in one of the virtual machines 144 on the first host 106a. In other embodiments, the upgrade service 143 can be a software component of the hypervisor, an operating system (not shown) of the first host 106a, or in other suitable forms.

The upgrade service 143 can be configured to provide input from the tenant site 143 to available upgrades applicable to one or more components of the first and second hosts 106a and 106b. In the illustrated embodiment as shown in FIG. 2A, the upgrade controller 126 can receive, compile, and transmit an upgrade list 150 only to the first host 106a via the underlay network 108 via a web service or other suitable services. The upgrade list 150 can contain data representing one or more upgrades applicable to all hosts 106 (e.g., the first and second hosts 106a and 106b in FIG. 2A), one or more of the network devices 112 (FIG. 1), or other suitable components of the distributed computing environment 100 that support cloud services to the tenant 101. In such embodiments, the upgrade service 143 can be configured to monitor execution of all tenant software applications 147 on multiple components in the distributed computing environment 100 and provide input to upgrade workflows, as described in more detail below. In other embodiments, the upgrade list 150 can contain data representing one or more upgrades that are applicable only to each component, for example, the first host 106a or a TOR switch (e.g., the network device 112a) supporting the first host 106a. In such embodiments, the upgrade controller 126 can transmit a distinct upgrade list 150 to each of the hosts 106 that support cloud services provided to the tenant 101.

In further embodiments, the upgrade list 150 can also contain data representing a progress threshold, a completion threshold, or other suitable data. Example entries for the upgrade list 150 is shown as follows:

| | | |
|---|---|---|
| Upgrade item: | operating system | TOR firmware |
| New version: | 2.0 | 3.1.1 |
| Released date: | Jan. 1, 2017 | Jan. 14, 2017 |
| To be initiated by: | Jan. 31, 2017 | Jan. 15, 2017 |
| To be completed by: | Mar. 1, 2017 | Jan. 31, 2017 |

As shown above, the first entry in the upgrade list 150 contains data representing a first upgrade to the operating system of the first host 106a along with a release date (i.e., 1/1/2017), a progress threshold (i.e., 1/31/2017), and a completion threshold (i.e., 3/1/2017). The second entry contains data representing a second upgrade to firmware of a TOR switch coupled to the first host 106a along with a release date (1/14/2017), a progress threshold (i.e., 1/15/2017), and a completion threshold (i.e., 1/31/2017).

As shown in FIG. 2B, upon receiving the upgrade list 150 (FIG. 2A), the upgrade service 143 can be configured to generate upgrade preference 152 based on (i) a current execution or operating status of the tenant software applications 147 and corresponding cloud services provided to the tenant and (ii) a set of tenant configurable rules. In one example, a tenant configurable rule can indicate that if all virtual machines 144 on a host 106 are in sleep mode, then the virtual machines 144 and related supporting components (e.g., the hypervisor 140) can be upgraded immediately. Another example rule can indicate that if a virtual machine 144 is actively executing a tenant software application 147 to facilitate a voice-over-IP conference call, then the virtual machine 144 cannot be upgraded immediately. The virtual machine 144 can, however, be upgraded at a later time at which the voice-over-IP conference call is scheduled or expected to be completed. In certain embodiments, the later time can be set also based on one or more of a progress threshold or a completion threshold included in the upgrade list 150. In other embodiments, the later time can be set based on possible session lengths or other suitable criteria. In further examples, the tenant 101 can configure a rule that indicate a preferred time/sequence of upgrading multiple hosts 106 each hosting one or more virtual machines 144 configured to execute a copy of the same tenant software application 147. For instance, the first and second hosts 106a and 106b can host the first and second virtual machines 144′ and 144″ that execute a copy of the same tenant software application 147. The tenant configurable rule can then indicate that the first virtual machine 144′ on the first host 106a can be upgraded before upgrading the second host 106b. Upon completion of upgrading the first host 106a, the second host 106b can be upgraded.

In further examples, the upgrade service 143 can also determine a preferred sequence of applying the upgrades in the upgrade list 150 based on corresponding tenant configurable rules. For example, when upgrades are available for both the operating system and hypervisor 140, the upgrade service 143 can determine that upgrades to the operating system is preferred to be applied before applying upgrades to the hypervisor 140. In another example, the upgrade service 143 can determine that upgrades to firmware of a TOR switch supporting the first host 106a can be applied before applying upgrades to the operating system because the virtual machines 144 on the first host 106a are executing tasks not requiring network communications.

In certain embodiments, the upgrade preference 152 transmitted from the first host 106a to the upgrade controller 126 can include preferred timing and/or sequence of applying the one or more upgrades in the upgrade list 150 (FIG. 2A) to all hosts 106, network devices 112 (FIG. 1), or other suitable components that support the cloud services provided to the tenant 101. In other embodiments, each of the first and second hosts 106a and 106b can transmit an upgrade preference 152 containing preferred timing and/or sequence of applying one or more upgrades to only the corresponding host 106 or other suitable components of the distributed computing environment 100 (FIG. 1).

As shown in FIG. 2C, upon receiving the upgrade preferences 152 (FIG. 2B), the upgrade controller 126 can be configured to develop upgrade workflows in view of the preferred timing and/or sequence in the received upgrade preference 152. For example, in one embodiment, if the received upgrade preference 152 indicates that one or more of the upgrades in the upgrade list 150 (FIG. 2A) can be applied immediately, the upgrade controller 126 can generate and transmit upgrade instructions 154 and 154′ to one or more of the first or second hosts 106a and 106b to immediately initialize application of the one or more upgrades. In another embodiment, if the received upgrade preference 152 indicates that one upgrade is preferred to be applied at a later time, the upgrade controller 126 can be configured to determine whether the later time violates one or more of a progress threshold or a completion threshold. If the later time does not violate any of the progress threshold or completion threshold, the upgrade controller 126 can be configured to generate and transmit upgrade instructions 154 and 154′ to the first or second hosts 106a and 106b to initialize application of the upgrade at or subsequent to the later time. If the later time violates any of the progression threshold or the completion threshold, the upgrade controller 126 can be configured to generate and transmit upgrade instructions 154 and 154′ to one or more of the first or second hosts 106a and 106b to initialize application of the upgrade at a time prescribed by, for example, a system policy configurable by a system operator of the distributed computing environment 100.

In certain embodiments, the upgrade controller 126 can develop upgrade workflows based on only the received upgrade preference 152 from the first host 106a when the upgrade preference 152 contains preferences applicable to all components in the distributed computing environment 100 that supports cloud services to the tenant 101. In other embodiments, the upgrade controller 126 can also receive multiple upgrade preferences 152 from multiple hosts 106 when the individual upgrade preferences 152 are applicable to only a corresponding host 106 and/or associated components (e.g., a connected TOR switch, a power distribution unit, etc.). In such embodiments, the upgrade controller 126 can also be configured to compile, sort, filter, or otherwise process the multiple upgrade preferences 152 before develop the upgrade workflows based thereon.

Several embodiments of the disclosed technology can improve speed and safety of applying upgrades in a distributed computing environment. Unlike in conventional techniques, upgrade timing and/or sequence can be determined based on preferences from the tenants 101, not just predefined system policies. As such, the hosts 106 and other resources that are indicated to be immediately upgradable can be upgraded without delay. Also, upgrades on hosts 106 or other resources supporting on-going cloud services to tenants 101 can be delayed such that interruption to providing the cloud services can be at least reduced.

FIGS. 3A-3C are schematic block diagrams showing hardware/software modules of certain components of the cloud computing environment 100 in FIG. 1 during upgrade operations when the hosts 106 serve multiple tenants 101 in accordance with embodiments of the present technology. As shown in FIG. 3A, the tenant sites 142 can each include multiple virtual machines 144 for multiple tenants 101 (FIG. 1). For example, the first host 106a and the second host 106b can both host the tenant site 142a and 142a′ for a first tenant 101a (FIG. 1). The first host 106a and the second host 106b can both host the tenant site 142b and 142b′ for a second tenant 101b (FIG. 1). The overlay network 108′ can include one or more virtual networks 146 that interconnect the tenant sites 142a and 142b across the first and second hosts 106a and 106b. For example, as shown in FIG. 3A, a first virtual network 142a interconnects the first tenant sites 142a and 142a′ at the first host 106a and the second host 106b. A second virtual network 146b interconnects the second tenant sites 142b and 142b′ at the first host 106a and the second host 106b.

Certain operations of the distributed computing environment 100 can be generally similar to those described above with reference to FIGS. 2A-2B. For example, as shown in FIG. 3A, the upgrade controller 126 can be configured to transmit upgrade lists 150 and 150′ to the first and second hosts 106a and 106b. In response, the upgrade services 143 corresponding to the first and second tenants 101a and 101b can be configured to determine and provide upgrade preferences 152 and 152′ to the upgrade controller 126, as shown in FIG. 3B.

Unlike the operations described above with reference to FIG. 2C, in addition to considering the received upgrade preferences 152 and 152′, the upgrade controller 126 can be configured to develop upgrade workflows also in view the multiple tenancy on each of the first and second hosts 106a and 106b. In one example, the upgrade controller 126 can instruct the first host 106a to apply certain upgrades only when the upgrade preferences 152 and 152′ from the first and second tenants 101a and 101b are unanimous. In another example, the upgrade controller 126 can also use one of the upgrade preferences 152 and 152′ as a tie breaker. In further examples, the upgrade controller 126 can also apply different weights to the upgrade preferences 152 and 152′. For instance, the upgrade controller 126 can apply more weights to the upgrade preference 152 from the first tenant 101a than the second tenant 101b such that conflicts of timing and/or sequence in a corresponding upgrade workflow are resolved in favor of the first tenant 101a. In other examples, the upgrade controller 126 can also apply quorums or other suitable criteria when developing the upgrade workflows. Once developed, the upgrade controller 126 can transmit upgrade instructs 154 to the first and second hosts 106a and 106b to cause application of the one or more upgrades, as described above with reference to FIG. 2C.

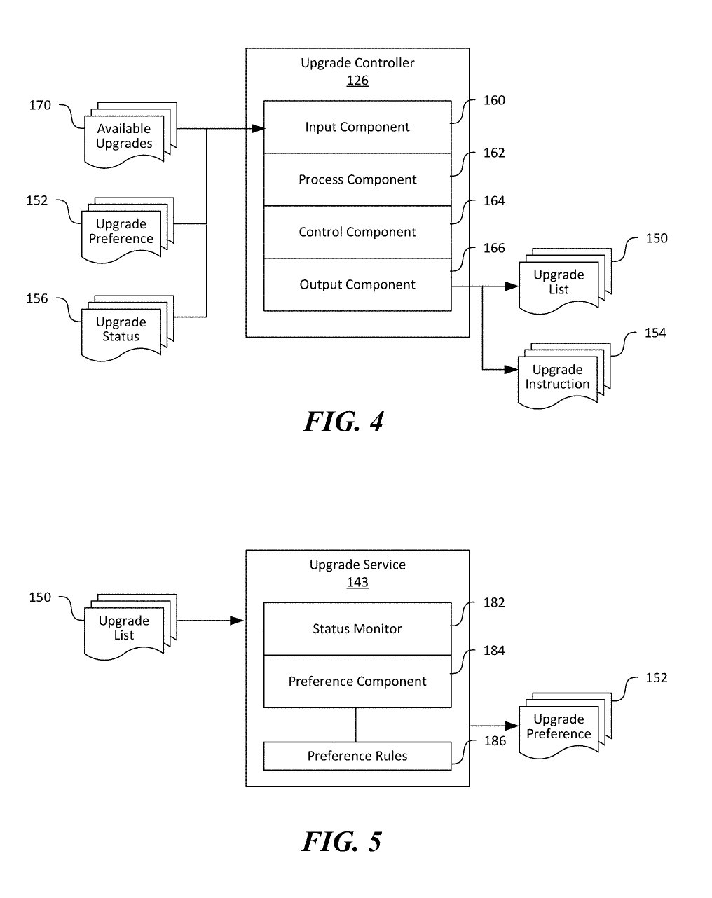

FIG. 4 is a block diagram showing software components suitable for the upgrade controller 126 of FIGS. 2A-3C in accordance with embodiments of the present technology. As shown in FIG. 4, the upgrade controller 126 can include an input component 160, a process component 162, a control component 164, and an output component 166. In one embodiment, all of the software components 160, 162, 164, and 166 can reside on a single computing device (e.g., a network server). In other embodiments, the foregoing software components can also reside on a plurality of distinct computing devices. In further embodiments, the software components may also include network interface components and/or other suitable modules or components (not shown).

The input component 160 can be configured to receive available upgrades 170, upgrade preferences 152, and upgrade status 156. In certain embodiments, the input component 160 can include query modules configured to query a software depository, a manufacture's software database, or other suitable sources for available upgrades 170. In other embodiments, the available upgrades 170 can be reported to the upgrade controller 126 periodically and received at the input component 160. In one embodiment, the input component 160 can include a network interface module configured to receive the available upgrades 170 as network messages formatted according to TCP/IP or other suitable network protocols. In other embodiments, the input component 160 can also include authentication or other suitable types of modules. The input component 160 can then forward the received available upgrades 170, upgrade preferences 152, and upgrade status 156 to the process component 162 and/or control component 164 for further processing.

Upon receiving the available upgrades 170, the process component 162 can be configured to compile, sort, filter, or otherwise process the available upgrades 170 into one or more upgrade list 150 applicable to components in the distributed computing environment 100 in FIG. 1. For example, in one embodiment, the process component 162 can be configured to determine whether one or more of the available upgrades 170 are cumulative, outdated, or otherwise can be omitted from the upgrade list 150. In another embodiment, the process component 162 can also be configured to sort the available upgrades 170 for each host 106 (FIG. 1), network device 112 (FIG. 1), or other suitable components of the distributed computing environment 100. The process component 162 can then forward the upgrade list 150 to the output component 166 which in turn transmit the upgrade list 150 to one or more of the hosts 106.

Upon receiving the upgrade preference 152, the process component 162 can be configured to develop upgrade workflows for applying one or more upgrades in the upgrade list 150 to components of the distributed computing environment 100. The process component 162 can be configured to determine upgrade workflows with timing and/or sequence when the upgrade preference 152 does not violate progression, completion, or other suitable enforcement rules. If one or more enforcement rules are violated, the process component 162 can be configured to temporarily or permanently disregard the received upgrade preference 152 and instead develop the upgrade workflows based on predefined system policies. If no enforcement rules are violated, the process component 162 can develop upgrade workflows based on the received upgrade preference and generate upgrade instructions 154 accordingly. The process component 162 can then forward the upgrade instruction 154 to the output component 166 which in turn forwards the upgrade instruction 154 to components of the distributed computing environment 100.

Upon receiving the upgrade status 156 containing progression and/or completion status of one or more upgrades in the upgrade list, the control component 164 can be configured to enforce the various enforcement rules. For example, when a particular upgrade has not been initiated within a progression threshold, the control component 164 can generate upgrade instruction 154 to initiate application of the upgrade according to system policies. In another example, when upgrades in the upgrade list 150 still remain after a completion threshold, the control component 164 can also generate upgrade instruction 154 to initiate application of the upgrade according to system policies. The control component 164 can then forward the upgrade instruction 154 to the output component 166 which in turn forwards the upgrade instruction 154 to components of the distributed computing environment 100.

FIG. 5 is a block diagram showing software components suitable for the upgrade service 143 of FIGS. 2A-3C in accordance with embodiments of the present technology. As shown in FIG. 5, the upgrade service 143 can include a status monitor 182 configured to query or otherwise determine a current operating status of various tenant software applications 147 (FIG. 2A), operating systems, hypervisors 140 (FIG. 2A), or other suitable components involved in providing cloud services to the tenants 101 (FIG. 1). The status monitor 182 can then forward the monitored status to the preference component 184. The preference component 184 can be configured to determine upgrade preference 152 based on the received upgrade list 150 and a set of tenant configurable preference rules 186, as described above with reference to FIGS. 2A-2C. Subsequently, the upgrade service 143 can be configured to transmit the upgrade preference 152 to the upgrade controller 126 in FIG. 4.

FIGS. 6A and 6B are flow diagrams illustrating aspects of a process 200 for system upgrade management in accordance with embodiments of the present technology. Even though the process 200 is described below as implemented in the distributed computing environment 100 of FIG. 1, In other embodiments, the process 200 can also be implemented in other suitable computing systems.

As shown in FIG. 6A, the process 200 can include transmitting a list of upgrade(s) to, for example, the hosts 106 in FIG. 1, at stage 202. The upgrades can be applicable to an individual host 106 or to multiple hosts 106 providing cloud services to a particular tenant 101 (FIG. 1). The process 200 can also include receiving upgrade preferences from, for example, the hosts 106 at stage 204. The upgrade preferences can include preferred timing and/or sequence of applying the various upgrades to the hosts 106 and/or other components of the distributed computing environment 100. The process 200 can then include developing one or more upgrade workflows based on the received upgrade preferences at stage 206. Example operations suitable for stage 206 are described below with reference to FIG. 6B. The process 200 can further include generating and issuing upgrade instructions based on the developed upgrade workflows at stage 208.

FIG. 6B illustrates example operations for developing upgrade workflows in FIG. 6A. As shown in FIG. 6B, the operations can include a first decision stage 210 to determine whether the upgrade preference indicates that a component can be upgraded immediately. In response to determining that the upgrade preference indicates that a component can be upgraded immediately, the operations include generating and transmitting instructions to upgrade immediately at stage 212. In response to determining that the upgrade preference does not indicate that a component can be upgraded immediately, the operations proceeds to a second decision stage 214 to determine whether a time included in the upgrade preference exceeds a progress threshold at which application of the upgrade is to be initiated. In response to determining that the time included in the upgrade preference exceeds the progress threshold, the operations include generating instructions to upgrade the component based on one or more system policies at stage 216.

In response to determining that the time included in the upgrade preference does not exceed the progress threshold, the operations include a third decision stage 218 to determine whether a completion threshold at which all of the upgrades are to be completed is exceeded. In response to determining that the completion threshold is exceeded, the operations reverts to generating instructions to upgrade the component based on one or more system policies at stage 216. In response to determining that the completion threshold is not exceeded, the operations include generating instructions to upgrade the component in accordance with the timing/sequence included in the upgrade preference at stage 220.

FIG. 7 is a flow diagram illustrating aspects of another process 230 for system upgrade management in accordance with embodiments of the present technology. As shown in FIG. 7, the process 230 includes receiving a list of available upgrades at stage 232 and monitoring operational status of various tenant software applications 147 (FIG. 2A) and/or corresponding cloud services at stage 233. Even though operations at stages 232 and 233 are shown in FIG. 7 as generally in parallel, in other embodiments, these operations can be performed sequentially or in other suitable orders.

The process 230 can then include determining upgrade preferences for the list of upgrades at stage 234. Such upgrade preferences can be based on the current operational status of various tenant software applications 147 and/or corresponding cloud services and a set of tenant configurable rules, as discussed above with reference to FIGS. 2A-2C. The process 230 can then include a decision stage to determine whether additional upgrades remain in the list. In response to determining that additional upgrades remain in the list, the process 230 reverts to determining upgrade preference at stage 234. In response to determining that additional upgrades do not remain in the list, the process 230 proceeds to transmitting the upgrade preferences at stage 238.

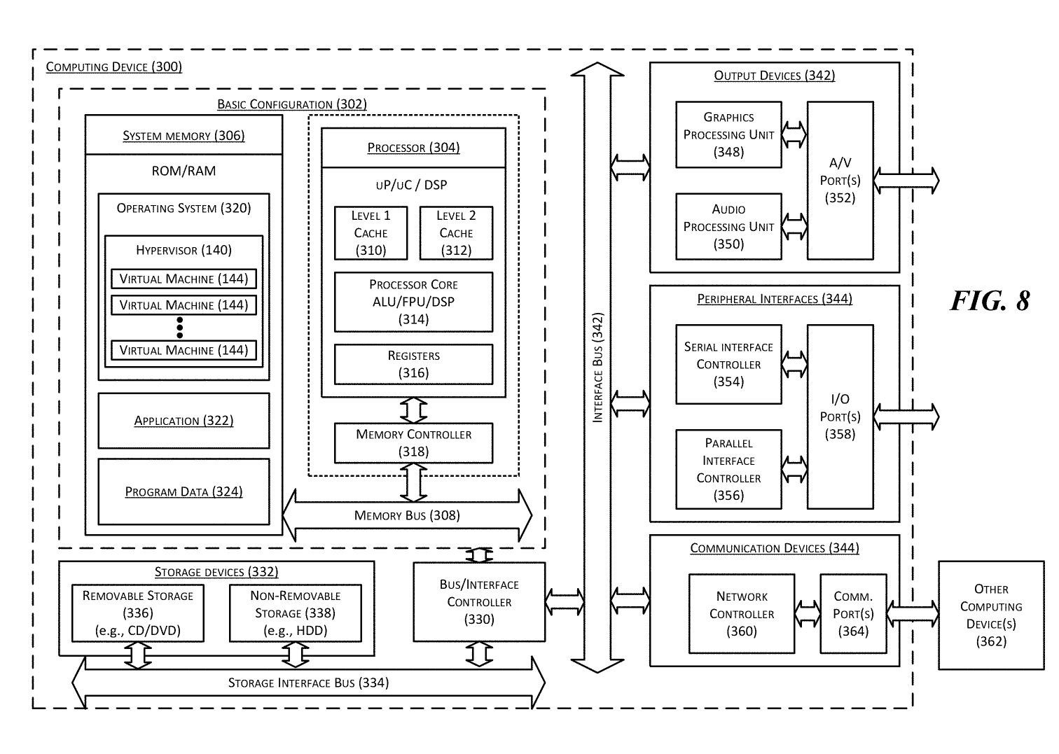

FIG. 8 is a computing device 300 suitable for certain components of the distributed computing environment 100 in FIG. 1, for example, the host 106, the client device 102, or the upgrade controller 126. In a very basic configuration 302, the computing device 300 can include one or more processors 304 and a system memory 306. A memory bus 308 can be used for communicating between processor 304 and system memory 306. Depending on the desired configuration, the processor 304 can be of any type including but not limited to a microprocessor (μP), a microcontroller (μC), a digital signal processor (DSP), or any combination thereof. The processor 304 can include one more levels of caching, such as a level-one cache 310 and a level-two cache 312, a processor core 314, and registers 316. An example processor core 314 can include an arithmetic logic unit (ALU), a floating point unit (FPU), a digital signal processing core (DSP Core), or any combination thereof. An example memory controller 318 can also be used with processor 304, or in some implementations memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. As shown in FIG. 8, the operating system 320 can include a hypervisor 140 for managing one or more virtual machines 144. This described basic configuration 302 is illustrated in FIG. 8 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more AN ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A method for system upgrade management in a distributed computing environment having multiple servers individually hosting one or more virtual machines, the method comprising:
transmitting data representing a list of one or more upgrades applicable to one or more components supporting a virtual machine executing on a server in the distributed computing environment, the server providing an upgrade service configurable by a tenant of the virtual machine to monitor a status of the virtual machine and determine a time at which the one or more components of the server can be upgraded;
receiving, from the upgrade service, an indication that one or more of the upgrades in the list can be applied to the one or more components of the server at one or more corresponding times; and
in response to receiving the indication,
developing an upgrade workflow for applying the list of upgrades according to the times in the received indication from the upgrade service; and
causing the one or more of the upgrades in the list to be applied to the one or more components of the server according to the developed upgrade workflow, thereby reducing interruption to of the virtual machine on the server during application of the one or more upgrades.

2. The method of claim 1 wherein:
receiving the indication includes receiving, from the upgrade service on the server, an indication that one or more of the upgrades in the list can be applied immediately; and
causing the one or more of the upgrades in the list to be applied to the server includes causing the one or more of the upgrades in the list to be applied to the server immediately according to the received indication.

3. The method of claim 1 wherein:
receiving the indication includes receiving, from the upgrade service on the server, an indication that one or more of the upgrades in the list can be applied at a later time; and
causing the one or more of the upgrades in the list to be applied to the server includes causing the one or more of the upgrades in the list to be applied to the server at or after the later time according to the received indication.

4. The method of claim 1 wherein:
at least two of the servers each hosting a virtual machine executing a copy of a same tenant software application;
receiving the indication includes receiving, from the upgrade service on the server, an indication that one of the upgrades in the list can be applied immediately to one of the servers while another one can be applied at a later time to the other server; and
causing the one or more of the upgrades in the list to be applied to the server includes causing the one of the upgrades in the list to be applied immediately to the one of the servers while causing the another one to be applied at or after the later time to the other server according to the received indication.

5. The method of claim 1 wherein:
receiving the indication includes receiving, from the upgrade service on the server, an indication that one or more of the upgrades in the list can be applied to the server at a later time; and
the method further includes:
determining whether the later time exceeds a progress threshold at which application of the upgrade is to be initiated; and
in response to determining that the later time does not exceed the progress threshold, causing the one or more of the upgrades in the list to be applied to the server at or after the later time according to the received indication.

6. The method of claim 1 wherein:
receiving the indication includes receiving, from the upgrade service on the server, an indication that one or more of the upgrades in the list can be applied to the server at a later time; and
the method further includes:
determining whether the later time exceeds a progress threshold at which application of the upgrade is to be initiated; and
in response to determining that the later time exceeds the progress threshold, causing the one or more of the upgrades in the list to be applied to the server at a predetermined time irrespective of the indication received from the upgrade service.

7. The method of claim 1, further comprising:
receiving, from the upgrade service on the server, an indication that one or more of the upgrades in the list can be applied to the server at one or more corresponding sequences; and
developing the upgrade workflow includes developing an upgrade workflow for applying the list of upgrades on the server according to the one or more times and sequences in the received indication.

8. The method of claim 1, further comprising:
determining whether all of the upgrades in the list have been applied to the server within a completion threshold at which all of the upgrades are to be completed; and
in response to determining that at least one upgrade in the list has not been applied to the server within the completion threshold, causing the at least one upgrade in the list to be applied to the server at a predetermined time irrespective of the indication received from the upgrade service.

9. The method of claim 1 wherein:
the tenant is a first tenant;
the virtual machine is a first virtual machine of the first tenant;
the upgrade service is a first upgrade service configurable by the first tenant to provide a first indication that the one or more of the upgrades in the list can be applied to the one or more components of the server at one or more first corresponding times;
the server also hosting a second virtual machine of a second tenant; and
the method further comprising:
receiving, from the second upgrade service, a second indication that one or more of the upgrades in the list can be applied to the one or more components of the server at one or more second corresponding times;
in response to receiving the first and second indication, developing the upgrade workflow for applying the list of upgrades based on both the first and second times in the received first and second indications, respectively.

10. The method of claim 9 wherein developing the upgrade workflow for applying the list of upgrades includes determining a time to apply the one or more upgrades, the determined time satisfied both the first time and the second time in the received first and second indications, respectively.

11. A method for system upgrade management in a distributed computing environment having multiple servers individually hosting one or more virtual machines, the method comprising:
receiving, from a upgrade controller, data representing a list of one or more upgrades applicable to a server supporting a virtual machine executing on the server in the distributed computing environment to provide a cloud computing service to a tenant;
in response to the receiving the data representing the list of one or more upgrades,
determining, according to a current operating status of the virtual machine in providing the cloud computing service to the tenant, a time at which the server supporting the virtual machine is upgradeable without interruption to providing the cloud computing service to the tenant;
transmitting, to the upgrade controller, a message containing the determined time at which the server is upgradable without interruption to providing the cloud computing service to the tenant; and
receiving, from the upgrade controller, an upgrade instruction instructing the server to apply the one or more upgrades at a time determined by the upgrade controller based on the time included in the transmitted message to the upgrade controller.

12. The method of claim 11 wherein the time determined by the upgrade controller is the same as the time included in the transmitted message to the upgrade controller.

13. The method of claim 11 wherein the time determined by the upgrade controller is different than the time included in the transmitted message to the upgrade controller.

14. The method of claim 11 wherein:
determining the time includes determining that the server supporting the virtual machine is immediately upgradeable without interruption to providing the cloud computing service to the tenant; and
receiving the upgrade instruction includes receiving the upgrade instruction instructing the server to apply the one or more upgrades immediately.

15. The method of claim 11 wherein:
determining the time includes determining that the server supporting the virtual machine is upgradeable at a later time without interruption to providing the cloud computing service to the tenant; and
receiving the upgrade instruction includes receiving the upgrade instruction instructing the server to apply the one or more upgrades at the later time when the later time does not exceed a progress threshold at which at least one of the upgrades is to be applied.

16. The method of claim 11 wherein:
determining the time includes determining that the server supporting the virtual machine is upgradeable at a later time without interruption to providing the cloud computing service to the tenant; and
receiving the upgrade instruction includes receiving the upgrade instruction instructing the server to apply the one or more upgrades at a time different than the later time when the later time exceeds a progress threshold at which at least one of the upgrades is to be applied.

17. The method of claim 11 wherein:
the message transmitted to the upgrade controller also contains a sequence according to which the one or more upgrades are applicable to the server supporting the virtual machine; and
receiving the upgrade instruction includes receiving the upgrade instruction instructing the server to apply the one or more upgrades at the determined time and the sequence according to which the one or more upgrades are applicable to the server supporting the virtual machine.

18. A computing device in a distributed computing environment having multiple servers interconnected to one another via a computer network, the computing device comprising:
a processor and a memory containing instructions executable by the processor to cause the processor to:
transmit, to a server in the distributed computing environment, data representing an available upgrade applicable to a component of the server on which a virtual machine is executed to provide a corresponding cloud computing service to a tenant;
receive, from the server, a message containing a preferred time by the tenant to apply the available upgrade to the component of the server; and
in response to receiving the message,
determine a time for applying the available upgrade to the component of the server in view of the preferred time by the tenant included in the received message; and
instruct the server to apply the upgrade to the component of the server according to the determined time, thereby reducing interruption to of the provided cloud computing service to the tenant when applying the available upgrade to the component of the server.

19. The computing device of claim 18 wherein determining the time includes:
determining whether the preferred time exceeds a progress threshold at which application of the upgrade is to be initiated; and
in response to determining that the preferred time does not exceed the progress threshold, set the determined time to be the same as the preferred time by the tenant.

20. The computing device of claim 18 wherein determining the time includes:
determining whether the preferred time exceeds a progress threshold at which application of the upgrade is to be initiated; and
in response to determining that the preferred time does exceed the progress threshold, set the determined time to be earlier than the preferred time by the tenant.
